(19) United States
(12) Patent Application Publication
(10) Pub. No.: US 2018/0220685 A1
(43) Pub. Date: Aug. 9, 2018

(54) PREPARATION AND COLOURING OF PULVERULENT FOODS

(71) Applicant: MERCK PATENT GMBH, Darmstadt (DE)

(72) Inventors: Alexander PETERS, Weinheim (DE); Ralf SCHWEINFURTH, Darmstadt (DE)

(73) Assignee: MERCK PATENT GMBH, Darmstadt (DE)

(21) Appl. No.: 15/890,983

(22) Filed: Feb. 7, 2018

(30) Foreign Application Priority Data
Feb. 7, 2017 (DE) 10 2017 001 109.5

(51) Int. Cl. A23L 5/43; A23L 23/10; C09C 1/00

(52) U.S. Cl. CPC A23L 5/43; A23L 23/10; C09C 1/0051; C09C 2200/1004; C09C 2200/304; C09C 2200/102; C09C 2200/308

(57) ABSTRACT

A process for the preparation and colouring of pulverulent foods which is distinguished by the fact that uncoloured pulverulent foods are mixed with effect pigments based on flake-form substrates.

The present invention relates to a process for the preparation and colouring of pulverulent foods which is distinguished by the fact that uncoloured pulverulent foods are mixed with effect pigments based on flake-form substrates.

Other than for functional uses, effect pigments based on flake-form substrates are increasingly being employed to enhance the appearance of products, for example in food technology or cosmetics, since attractive colours and effects bring about pleasant subjective impressions for the observer and consumer. In the preparation of effect pigments, stringent requirements are made of the purity and quality of the pigments. Effect pigments, preferably pearlescent and interference pigments, are therefore also employed in the foods sector for improving the colour effect or for imparting colour.

On use in the foods sector, pearlescent pigments can be suspended in a multiplicity of liquids, such as, for example, water, ethanol, acids or even oil. A homogeneous distribution or suspension of the pearlescent pigments arises here.

However, there is a need to colour foods in the form of powders or granules directly without having to suspend them in a liquid beforehand. Hitherto, it has only been possible to apply colourants for ingredients, for example for pulverulent soups, such as, for example, noodles in small pieces, separately to the surface if a fixing agent or adhesive is used. This means a further requisite process step, and the additional use of other additives, such as, for example, celluloses or shellac, for the adhesion or fixing of the colourant to the respective product surface.

An object of the present invention is therefore to provide a process for colouring pulverulent foods which is improved over the prior art with respect to cost effectiveness and acceptance.

Surprisingly, it has been found that effect pigments based on flake-form substrates can advantageously be employed for colouring pulverulent foods without these ingredients having to be coloured separately on the surface. Thus, for example, noodles in small pieces can be coloured by means of pearlescent pigments by simple mixing without separate pre-treatment or pre-colouring. This makes the use of additional binders or fixing agents, such as, for example, celluloses, gum arabic, shellac, etc., superfluous. Adequate fixing or adhesion of the effect pigments to the product surface of a dried or pulverulent food takes place through pure physical adhesion effects caused by the simple mixing of the ingredients with one or more effect pigments. Besides the simple handling, it is advantageous that no further additive is necessary in the food, since additives should generally be restricted to the absolutely necessary, i.e. every further additive is undesired.

The term “pulverulent foods” in this application encompasses all foods in powder or granular form, in particular seasoning, seasoning mixtures, baking mixtures, premixes for the meat products industry, instant drinks or instant soups. The term preferably encompasses instant drinks or instant soups. These are particularly preferably instant soups, such as, for example, packet soups, dry soups, for example noodle soups, or similar products. The food powder or granules here generally has particle sizes of <10 mm, preferably <8 mm and in particular <5 mm.

Instant soups, such as, for example, noodle soups, are industrially produced mixtures of dry ingredients, such as noodles, vegetables, fat, flavour enhancers, such as, for example, monosodium glutamate, flavourings and seasoning, which have been pre-cooked or pre-treated in such a way that they give rise to a ready-to-eat soup by mixing with hot water and possibly brief boiling. Besides the simple and rapid nature of preparation, instant soups are distinguished by a very long shelf life, since they contain virtually no water and are packaged in an air-tight manner.

In order to achieve a particular optical colour effect, such as, for example, a pearlescent effect, one or more effect pigments, preferably pearlescent pigments and/or interference pigments, are added to the pulverulent food and mixed therewith. After corresponding preparation of these foods treated in this way (for example by pouring-on of hot water), the desired optical effect, for example a pearlescent effect, arises, for example in the finished soup. In clear soups in particular, this optical effect is shown off very attractively.

Preferred effect pigments are pearlescent pigments and interference pigments based on flake-form substrates which have been coated with one or more metal oxides and/or metal hydroxides.

The term flake-form substrates is taken to mean all flake-form substrates that are known to the person skilled in the art. Suitable base substrates for the effect pigments, such as, for example, pearlescent pigments and interference pigments, are transparent or semitransparent flake-form substrates. Particularly suitable are phyllosilicates, talc, kaolin, flake-form iron oxides or aluminium oxides, glass flakes, SiO₂ flakes, TiO₂ flakes, flake-form mixed oxides, such as, for example, FeTiO₃, Fe₂TiO₅, or other comparable materials, depending on the respective legal approval for use in foods or pharmaceutical products.

The size of the base substrates is not crucial per se and can be matched to the respective intended application. In general, the flake-form substrates have a thickness of 0.005 to 10 μm, in particular from 0.05 to 5 μm. The size in the two other dimensions is usually 1 to 500 μm, preferably 2 to 200 μm and in particular 5 to 150 μm. Very particularly preferred pearlescent pigments have particle sizes of 10-60 μm or 5-25 μm or 10-150 μm or 5-50 μm.

Preferred effect pigments, such as, for example, pearlescent pigments, are based on natural mica flakes, synthetic mica flakes, SiO₂ flakes, Al₂O₃ flakes, TiO₂ flakes, glass flakes, Fe₂O₃ flakes, in particular synthetic mica flakes, natural mica flakes and SiO₂ flakes (No. E555 or E551 in the list of food additives approved in the European Union). The synthetic flakes, such as, for example, synthetic mica flakes, SiO₂ flakes, Al₂O₃ flakes, TiO₂ flakes and glass flakes, may be doped or undoped. Suitable dopants are, inter alia, metal oxides, such as, for example, TiO₂, ZrO₂ and SnO₂.

The pearlescent pigments used are pigments based on flake-form, transparent or semitransparent substrates comprising, for example, phyllosilicates, such as, for example, natural mica, synthetic mica, talc, sericite or kaolin, or comprising glass or other silicate materials, which are coated with coloured or colourless metal oxides, such as, for example, TiO₂, titanium suboxides, titanium oxynitrides, Fe₂O₃, Fe₃O₄, SnO₂, ZnO and other metal oxides, alone or in a mixture in a homogeneous layer or in successive layers. Particularly preferred pearlescent pigments based on synthetic or natural mica flakes are coated with one or more metal oxides from the group TiO₂, Fe₂O₃ and Fe₃O₄ or mixtures thereof or have a multilayer coating consisting of alternating high- and low-refractive-index layers, such as, for example, TiO₂— SiO₂— TiO₂.

Preference is furthermore given to TiO₂— and/or Fe₂O₃-coated SiO₂ or Al₂O₃ flakes. The coating of the SiO₂ flakes with one or more metal oxides can be carried out, for example, as described in WO 93/08237 (wet-chemical coating) or DE-A 196 14 637 (CVD method).

The metal oxides applied to the flake-form substrates are also preferably materials in food grade which are suitable for human consumption (No. E171 (TiO₂) or E172 (iron oxide) in the list of food additives approved in the European Union).

The term titanium dioxide is taken to mean TiO₂ (No. E171 in the list of food additives approved in the European Union).

The term iron oxide is taken to mean both Fe₂O₃ and Fe₃O₄ (No. E172 in the list of food additives approved in the European Union).

Preference is furthermore given to pearlescent pigment mixtures which have different particle sizes. Particular effects can be achieved if pearlescent pigments having “small” particle sizes, such as, for example, 5-25 μm or 10-60 μm, are mixed with pearlescent pigments having “large” particle sizes, such as, for example, 10-150 μm.

The thickness of the individual layers, preferably one or more metal oxide layers, on the base substrate is preferably 10-500 nm, in particular 20-400 nm and very particularly preferably 30-350 nm.

In the case of multilayered pigments, which preferably have alternating high- and low-refractive-index layers (A)(B)(A) on the substrate surface, the high-refractive-index layer (layer A) generally has layer thicknesses of 10-500 nm, preferably 20-400 nm and in particular 30-350 nm. The thickness of the low-refractive-index layer (layer B) is preferably 10-500 nm, preferably 20-400 nm, in particular 30-350 nm.

High-refractive-index layers in this application are taken to mean layers having a refractive index of 1.8, such as, for example, TiO₂, Fe₂O₃ or Fe₃O₄, whereas low-refractive-index layers have a refractive index of <1.8, such as, for example, SiO₂, Al₂O₃ or AlO(OH).

The effect pigments, preferably pearlescent pigments, may comprise a plurality of identical or different combinations of layer packages, but coating of the substrate with only one layer package (A) (B) (A) in the case of multilayered pigments is preferred. In order to increase the tinting strength, the pigment according to the invention may comprise up to 4 layer packages, although in this case the thickness of all layers on the substrate should not exceed 3 μm. In the case of multilayered pigments having 3 or more layers on the substrate surface, an odd number of layers is preferably applied to the flake-form substrate, in each case with a high-refractive-index layer in the innermost and outermost position. A structure of three optical interference layers in the sequence (A) (B) (A) is particularly preferred. A suitable high-refractive-index layer is preferably TiO₂, Fe₂O₃ and/or Fe₃O₄ or a mixture of titanium oxide and iron oxide. The TiO₂ here can be in the rutile modification or in the anatase modification.

Suitable colourless low-refractive-index materials which are suitable for the coating (B) are preferably metal oxides or the corresponding oxide hydrates, such as, for example, SiO₂, Al₂O₃, AlO(OH), B₂O₃, MgF₂, MgSiO₃ or a mixture of the said metal oxides, in accordance with the legal approvals for use in foods or pharmaceutical products.

Particularly preferred pearlescent pigments for the foods sector are mica flakes (synthetic or natural) or SiO₂ flakes, which are coated with a metal oxide layer, preferably TiO₂ or Fe₂O₃, furthermore Fe₃O₄ or a mixture of TiO₂ and Fe₂O₃. The thickness of the metal-oxide layer or metal-oxide mixed layer is 10 nm to 500 nm. The thicknesses of the flakes are in the range from 200 nm to 900 nm. Depending on the thickness of the flakes employed and the metal oxide layers applied and on the type of metal oxide, pigments of this type are distinguished by particularly intense interference colours and/or by strong angle-dependent colour flop effects. The latter are apparent inasmuch as an observer perceives different colours on changing his observation position relative to the pigmented object.

Preferred effect pigments are selected, in particular, from the pigments mentioned below where the +indicates added layers:
natural mica flakes+TiO₂
natural mica flakes+Fe₂O₃
natural mica flakes+Fe₃O₄
natural mica flakes+TiO₂+Fe₂O₃
natural mica flakes+TiO₂+Fe₃O₄
natural mica flakes+Fe₂O₃+TiO₂
natural mica flakes+Fe₃O₄+TiO₂
natural mica flakes+TiO₂/Fe₂O₃ mixture
natural mica flakes+TiO₂/Fe₃O₄ mixture
synthetic mica flakes+TiO₂
synthetic mica flakes+Fe₂O₃
synthetic mica flakes+Fe₃O₄
synthetic mica flakes+TiO₂+Fe₂O₃
synthetic mica flakes+TiO₂+Fe₃O₄
synthetic mica flakes+Fe₂O₃+TiO₂
synthetic mica flakes+Fe₃O₄+TiO₂
synthetic mica flakes+TiO₂/Fe₂O₃ mixture
synthetic mica flakes+TiO₂/Fe₃O₄ mixture
SiO₂ flakes+TiO₂
SiO₂ flakes+Fe₂O₃
SiO₂ flakes+Fe₃O₄
SiO₂ flakes+TiO₂+Fe₂O₃
SiO₂ flakes+TiO₂+Fe₃O₄
SiO₂ flakes+Fe₂O₃+TiO₂
SiO₂ flakes+Fe₃O₄+TiO₂
SiO₂ flakes+TiO₂/Fe₂O₃ mixture
SiO₂ flakes+TiO₂/Fe₃O₄ mixture
natural mica flakes+TiO₂+SiO₂+TiO₂
natural mica flakes+Fe₂O₃+SiO₂+TiO₂
natural mica flakes+TiO₂+SiO₂+Fe₂O₃
natural mica flakes+TiO₂+SiO₂+Fe₃O₄
natural mica flakes+TiO₂/Fe₂O₃ mixture+SiO₂+Fe₂O₃
natural mica flakes+TiO₂/Fe₂O₃ mixture+SiO₂+TiO₂/Fe₂O₃ mixture
natural mica flakes+Fe₂O₃ mixture+SiO₂+TiO₂/Fe₂O₃ mixture
synthetic mica flakes+TiO₂+SiO₂+TiO₂
synthetic mica flakes+Fe₂O₃+SiO₂+TiO₂
synthetic mica flakes+TiO₂+SiO₂+Fe₂O₃
synthetic mica flakes+TiO₂+SiO₂+Fe₃O₄
synthetic mica flakes+TiO₂/Fe₂O₃ mixture+SiO₂+Fe₂O₃
synthetic mica flakes+TiO₂/Fe₂O₃ mixture+SiO₂+TiO₂/Fe₂O₃ mixture
synthetic mica flakes+Fe₂O₃ mixture+SiO₂+TiO₂/Fe₂O₃ mixture
SiO₂ flakes+TiO₂+SiO₂+TiO₂
SiO₂ flakes+Fe₂O₃+SiO₂+TiO₂
SiO₂ flakes+TiO₂+SiO₂+Fe₂O₃
SiO₂ flakes+TiO₂+SiO₂+Fe₃O₄
SiO₂ flakes+TiO₂/Fe₂O₃ mixture+SiO₂+Fe₂O₃
SiO₂ flakes+TiO₂/Fe₂O₃ mixture+SiO₂+TiO₂/Fe₂O₃ mixture
SiO₂ flakes+Fe₂O₃ mixture+SiO₂+TiO₂/Fe₂O₃ mixture.

Pearlescent and interference pigments which have been approved for the foods sector are commercially available, for example under the Candurin® brand from Merck KGaA.

The resulting coloured foods with the pigments are distinguished by a colour effect which is based on light refraction or reflection by the effect pigments and brings about pleasant subjective impressions for the observer and consumer. Mixing of one or more effect pigments with the pulverulent food enables the products to be provided with interesting hues and at the same time enables desired new variants or nuances of hues owing to new fashion trends to be taken into account.

The pulverulent food colouring according to the invention can be carried out using both individual effect pigments and also mixtures of different effect pigments, in particular pearlescent pigments. No limits are set for the mixing ratio here. However, it is also possible to employ a mixture of effect pigments which differ merely through their particle sizes, i.e. a mixture of “coarse” with “fine” pigments.

The pulverulent food typically comprises 0.01-8% by weight, preferably 0.02-4% by weight, based on the food, of one or more effect pigments, in particular pearlescent pigments and/or interference pigments. The requisite amount of effect pigment increases with the amount of water to be used for preparation of the pulverulent food.

The effect pigments, preferably pearlescent pigments, can be mixed with pulverulent foods and/or constituents thereof by simple, standard industrial mixing processes. The effect pigments themselves have no tendency towards agglomeration. The mixing also leads to a very uniform distribution of the effect pigments in the pulverulent food, where, depending on the physical nature of the ingredients, more or less strong physical fixing to the respective product surfaces is observed. This colour fixing is also maintained after and during the cooking process of pulverulent soups and is visually evident to the consumer in the finished end product.

The invention likewise relates to pulverulent foods which comprise fat, flavouring, seasoning, one or more effect pigments, and optionally further ingredients.

The invention furthermore relates to instant soups or dry soups which comprise dried vegetables, fat, seasoning, one or more effect pigments and optionally further ingredients, for example noodles, thickeners, flavour enhancers, etc. Particular preference is given to instant soups, in particular noodle soups.

The effect pigment, preferably pearlescent pigment, is preferably mixed with the pulverulent foods and/or constituents thereof without any agent for adhesion or fixing of the pigment to the pulverulent food and/or constituents thereof.

The effect pigment, preferably pearlescent pigment, is preferably mixed with the pulverulent foods and/or constituents thereof without suspending the pigment in a liquid.

The following examples are intended to explain the invention, but without limiting it. Unless otherwise indicated, percentages denote percent by weight.

### EXAMPLES

### Procedure for Examples 1-10

The amounts of instant soup and pearlescent pigment shown in the table are mixed by shaking, and the resultant mixtures are stirred into the amounts of boiling water shown in the examples. The mixture is then left to boil for a further 5 minutes. After boiling, the added pearlescent pigment is clearly visible both in the liquid phase of the soup and also on the ingredients, such as, for example, the noodles.

| | | | | Addition |
|---|---|---|---|---|
| | | Amount | | of boiling |
| No. | Instant soup | of soup | Pearlescent pigment | water |
| 1 | Maggi | 97.5 g | Candurin ® Gold Sparkle | 1000 ml |
| | “Alphabet | | 2.5 g | |
| | Soup” | | | |
| 2 | Maggi “Spring | 62 g | Candurin ® Gold Lustre | 1000 ml |
| | Soup” | | 1 g | |
| 3 | Maggi | 58.5 g | Candurin ® NXT Ruby | 1000 ml |
| | “Firefighter | | Red | |
| | Soup” | | 1.5 g | |
| 4 | Maggi | 58 g | Candurin ® Red Lustre | 1000 ml |
| | “Firefighter | | 1 g | |
| | Soup” | | Candurin ® Red Sparkle | |
| | | | 1 g | |
| 5 | Maggi “Knight | 97 g | Candurin ® Silver Sparkle | 1000 ml |
| | Soup” | | 3 g | |
| 6 | Maggi “Star | 95 g | Candurin ® Gold Sparkle | 750 ml |
| | Soup” | | 5 g | |
| 7 | Knorr | 77.5 g | Candurin ® Gold Shimmer | 750 ml |
| | “Alphabet | | 4.5 g | |
| | Soup” | | | |
| 8 | Knorr | 76.5 g | Candurin ® Silver Sparkle | 750 ml |
| | “Number Soup” | | 7.5 g | |
| 9 | Knorr | 81 g | Candurin ® Red Sparkle | 750 ml |
| | “Number Soup” | | 3 g | |
| 10 | Knorr | 81.4 g | Candurin ® Silver Lustre | 750 ml |
| | “Alphabet | | 0.3 g | |
| | Soup” | | Candurin ® Gold Lustre | |
| | | | 0.3 g | |
| 11 | Maggi “Star | 95 g | Candurin ® Gold Sparkle | 1000 ml |
| | Soup” | | 6 g | |

The pearlescent and interference pigments used in the examples (Candurin® pigments from Merck) based on mica flakes or SiO₂ flakes have the following composition and particle sizes:
Candurin® Gold Lustre: Mica (E555) coated with TiO₂ (E171) und Fe₂O₃ (E172ii); 10-60 μm
Candurin® Gold Sparkle: Mica (E555) coated with TiO₂ (E171) und Fe₂O₃ (E172ii); 10-150 μm
Candurin® Gold Shimmer: Mica (E555) coated with TiO₂ (E171); 10-60 μm
Candurin Silver Lustre: Mica (E555) coated with TiO₂ (E171); 10-60 μm
Candurin® Silver Sparkle: Mica (E555) coated with TiO₂ (E171); 10-150 μm
Candurin® Red Sparkle: Mica (E555) coated with Fe₂O₃ (E172ii); 10-150 μm
Candurin® NXT Ruby Red: SiO₂ flakes (E551) coated with Fe₂O₃ (E172ii); 5-50 μm
Candurin® Red Lustre: Mica (E555) coated with Fe₂O₃ (E172ii); 10-60 μm

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosure[s] of all applications, patents and publications, cited herein and of corresponding German application No. 102017001109.5, filed Feb. 7, 2017 is [are] incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Process for the preparation of a coloured, pulverulent food, comprising mixing an uncoloured pulverulent food with one or more effect pigments based on a flake-form substrate.

2. The process of claim 1, wherein the effect pigment is a pearlescent pigment, an interference pigment and/or a multilayered pigment.

3. The process of claim 1, wherein the flake-form substrate is a natural mica flake, a synthetic mica flake, talc, kaolin, a glass flake, a silicon dioxide flake, a titanium dioxide flake, an aluminium oxide flake or an iron oxide flake.

4. The process of claim 1, wherein the flake-form substrate is completely coated with one or more layers of metal oxides and/or metal oxide mixtures.

5. The process of claim 1, wherein the flake-form substrate is coated with titanium dioxide and/or iron oxide.

6. The process of claim 1, wherein the effect pigment is selected from the following pigments wherein the +indicates an added layer:
natural mica flakes+TiO₂
natural mica flakes+Fe₂O₃
natural mica flakes+Fe₃O₄
natural mica flakes+TiO₂+Fe₂O₃
natural mica flakes+TiO₂+Fe₃O₄
natural mica flakes+Fe₂O₃+TiO₂
natural mica flakes+Fe₃O₄+TiO₂
natural mica flakes+TiO₂/Fe₂O₃ mixture
natural mica flakes+TiO₂/Fe₃O₄ mixture
synthetic mica flakes+TiO₂
synthetic mica flakes+Fe₂O₃
synthetic mica flakes+Fe₃O₄
synthetic mica flakes+TiO₂+Fe₂O₃
synthetic mica flakes+TiO₂+Fe₃O₄
synthetic mica flakes+Fe₂O₃+TiO₂
synthetic mica flakes+Fe₃O₄+TiO₂
synthetic mica flakes+TiO₂/Fe₂O₃ mixture
synthetic mica flakes+TiO₂/Fe₃O₄ mixture
SiO₂ flakes+TiO₂
SiO₂ flakes+Fe₂O₃
SiO₂ flakes+Fe₃O₄
SiO₂ flakes+TiO₂+Fe₂O₃
SiO₂ flakes+TiO₂+Fe₃O₄
SiO₂ flakes+Fe₂O₃+TiO₂
SiO₂ flakes+Fe₃O₄+TiO₂
SiO₂ flakes+TiO₂/Fe₂O₃ mixture
SiO₂ flakes+TiO₂/Fe₃O₄ mixture
natural mica flakes+TiO₂+SiO₂+TiO₂
natural mica flakes+Fe₂O₃+SiO₂+TiO₂
natural mica flakes+TiO₂+SiO₂+Fe₂O₃
natural mica flakes+TiO₂+SiO₂+Fe₃O₄
natural mica flakes+TiO₂/Fe₂O₃ mixture+SiO₂+Fe₂O₃
natural mica flakes+TiO₂/Fe₂O₃ mixture+SiO₂+TiO₂/Fe₂O₃ mixture
natural mica flakes+Fe₂O₃ mixture+SiO₂+TiO₂/Fe₂O₃ mixture
synthetic mica flakes+TiO₂+SiO₂+TiO₂
synthetic mica flakes+Fe₂O₃+SiO₂+TiO₂
synthetic mica flakes+TiO₂+SiO₂+Fe₂O₃
synthetic mica flakes+TiO₂+SiO₂+Fe₃O₄
synthetic mica flakes+TiO₂/Fe₂O₃ mixture+SiO₂+Fe₂O₃
synthetic mica flakes+TiO₂/Fe₂O₃ mixture+SiO₂+TiO₂/Fe₂O₃ mixture
synthetic mica flakes+Fe₂O₃ mixture+SiO₂+TiO₂/Fe₂O₃ mixture
SiO₂ flakess+TiO₂+SiO₂+TiO₂
SiO₂ flakess+Fe₂O₃+SiO₂+TiO₂
SiO₂ flakess+TiO₂+SiO₂+Fe₂O₃
SiO₂ flakess+TiO₂+SiO₂+Fe₃O₄
SiO₂ flakess+TiO₂/Fe₂O₃ mixture+SiO₂+Fe₂O₃
SiO₂ flakess+TiO₂/Fe₂O₃ mixture+SiO₂+TiO₂/Fe₂O₃ mixture
SiO₂ flakess+Fe₂O₃ mixture+SiO₂+TiO₂/Fe₂O₃ mixture.

7. The process of claim 1, wherein effect pigment is provided in an amount of 0.01-8% by weight, based on the weight of the pulverulent food.

8. The process of claim 1, wherein the pulverulent food is an instant soup, a dry soup, an instant drink, a seasoning, a seasoning mixture, a baking mixture, a premix for a meat product.

9. A pulverulent food comprising a food in pulverulent form, one or more of fat, flavouring and seasoning, and one or more effect pigments based on a flake-form substrate and optionally further ingredients.

10. Instant soup or dry soup, further comprising dried vegetables, fat, seasoning, one or more effect pigments based on a flake-form substrate and optionally further ingredients.

11. Instant soup or dry soup according to claim 10, which is a noodle soup.

12. The process of claim 1, wherein the effect pigment is mixed with the pulverulent food without any agent for adhesion or fixing of the pigment to the pulverulent food.

13. The process of claim 1, wherein the effect pigment is mixed with the pulverulent food without suspending the pigment in a liquid.

14. The process of claim 1, wherein the effect pigment is a pearlescent pigment.
